(19) United States
(12) Patent Application Publication
(10) Pub. No.: US 2010/0073336 A1
(43) Pub. Date: Mar. 25, 2010

(54) APPARATUS FOR DISPLAYING MARK OF DISPLAY DEVICE AND DISPLAY DEVICE

(75) Inventors: Kyung-Won Lee, Gumi-city (KR); Oh-Kwan Kwon, Gumi-City (KR); Soon-Koo Park, Gumi-city (KR); Jae-Min Hyun, Gumi-City (KR)

Correspondence Address: BIRCH STEWART KOLASCH & BIRCH, PO BOX 747, FALLS CHURCH, VA, 22040-0747, US

(73) Assignee: LG ELECTRONICS INC., SEOUL (KR)

(21) Appl. No.: 12/522,534

(22) PCT Filed: Dec. 10, 2008
(86) PCT No.: PCT/KR08/07319

§ 371 Date: Dec. 11, 2009

(30) Foreign Application Priority Data
Dec. 28, 2007 (KR) 10-2007-0140925

(51) Int. Cl. G09G 5/00; G08B 21/00

(52) U.S. Cl. 345/204; 340/689

(57) ABSTRACT

Provided is an apparatus for properly displaying a mark of a display device although the display device is pivoted. The apparatus includes a display unit, at least two mark units, a state detection unit, and a control unit. The display unit displays images. The mark units are disposed at a front region of the display unit and spaced apart from each other. The state detection unit detects whether the display unit is substantially in a horizontal or vertical orientation. The control unit operates at least one of the mark units according to a detection signal of the state detection unit.

### TECHNICAL FIELD

The present disclosure relates to a display device, and more particularly, to an apparatus for displaying a mark of a pivotable display device properly for a user according to the orientation of the pivotable display device.

### BACKGROUND ART

Recently, the use of flat display devices such as liquid crystal displays (LCDs) and plasma display panels (PDPs) is increased.

In some LCDs or PDPs, a case accommodating a flat display panel is pivotably connected to a stand so that the flat display panel can be freely rotated. In this case, when a user rotates the display panel by 90 degrees in a desired direction by using a pivot structure, the output format of image signals should be converted according to the rotated angle of the display panel.

In general, a mark of a display device is located at a lower center position of the front surface of the display device when the display device is oriented in landscape mode—the state where the display device is horizontally oriented when viewed from the front. Thus, when the display device is vertically oriented using a pivot structure, the mark of the display device is vertically oriented so that it is uncomfortable for a user to read the mark. The manufacturer name, product name, or manufacturer logo may be on the mark.

That is, in the related art, a metallic mark is attached to a product, or a mark is printed on an inner side of an acryl plate using an opaque paint.

However, since such a mark is fixed to a position, the mark is rotated together with a display device when the display device is rotated using a pivot structure. Therefore, when the mark is reversely or vertically displayed, the aesthetics of the display device may be deteriorated.

In addition, since such a mark is perceived via light reflected from the mark, persons cannot perceive the mark correctly if there is no illumination.

### DISCLOSURE

### Technical Problem

Accordingly, embodiments provide a display device and a mark displaying apparatus of the display device, which are configured to display a mark properly even when the display device is pivoted.

Embodiments also provide a display device and a mark displaying apparatus of the display device, in which a mark can be turned on to make the mark visible regardless of external illumination.

### Technical Solution

In one embodiment, there is provided an apparatus for displaying a mark of a display device, the apparatus including: a display unit configured to display images; at least two mark units disposed at a front region of the display unit and spaced apart from each other; a state detection unit configured to detect whether the display unit is substantially in a horizontal or vertical orientation; and a control unit configured to operate at least one of the mark units according to a detection signal of the state detection unit.

In another embodiment, a display device including: a display panel; a back cover configured to protect a rear side of the display panel; an inner frame configured to support an edge portion of the display panel; at least two opening formed in the inner frame and spaced apart from each other; light emitting units aligned with the openings, respectively; a front filter configured to cover at least the display panel; a filter fixing member configured to support the front filter; and a front frame configured to cover an edge portion of the front filter.

In further another embodiment, a display device including: a pivotable display panel configured to display images; and at least two mark units disposed at outer regions of the display panel that are not used for displaying images, the mark units being spaced apart from each other, wherein each of the mark units includes: a light emitting unit; and a mark region disposed at a front side of the light emitting unit for selectively transmitting light emitted from the light emitting unit.

### ADVANTAGEOUS EFFECTS

According to embodiments, although the display device is pivoted, a mark can be properly displayed according to the pivoted orientation of the display device. Furthermore, the mark can be perceived regardless of the state of external illumination.

### DESCRIPTION OF DRAWINGS

FIG. 1 is a block diagram illustrating a mark displaying apparatus of a display device according to an embodiment.

FIG. 2 is a view illustrating a mark displaying example according to an embodiment.

FIG. 3 is a schematic view illustrating a mark unit illustrated in FIG. 2, according to an embodiment.

FIGS. 4 and 5 a partial cut-away view and a partial exploded cut-away view of a display device for explaining a mark unit in detail according to an embodiment.

FIG. 6 is a view an operation of a display device according to an embodiment.

FIG. 7 is an exploded perspective view illustrating a mark unit according to another embodiment.

FIG. 8 is a block diagram illustrating a mark displaying apparatus of a display device according to another embodiment.

FIG. 9 is an exploded perspective view illustrating a display device according to another embodiment.

### MODE FOR INVENTION

An apparatus for displaying a mark of a display device and a display device will now be described in detail with reference to the accompanying drawings, in which exemplary embodiments are shown.

### Embodiment

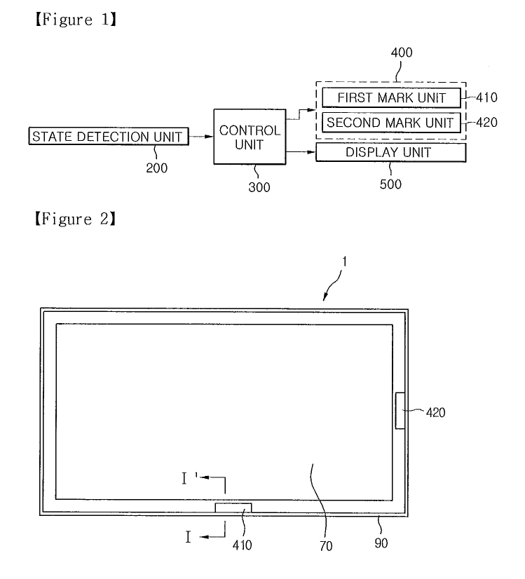

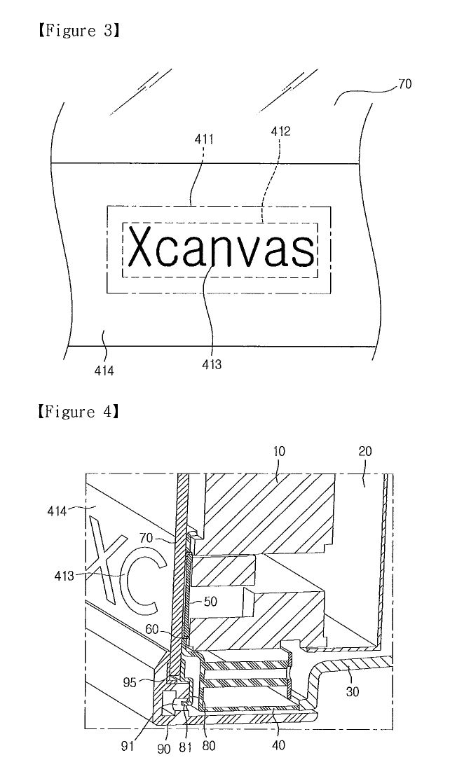

FIG. 1 is a block diagram illustrating a mark displaying apparatus of a display device according to an embodiment; FIG. 2 is a view illustrating a mark displaying example according to an embodiment; and FIG. 3 is a schematic view illustrating a mark unit illustrated in FIG. 2, according to an embodiment.

Referring to FIG. 1, the mark displaying apparatus of a display device includes a display unit 500 configured to display images, at least one mark unit 400 disposed at a frontal area of the display unit 500, a state detection unit 200 configured to detect whether the orientation of the display unit 500 is substantially horizontal or vertical when viewed from the front of the display unit 500, and a control unit 300 configured to control the mark unit 400 according to the state of the display unit 500 detected by the state detection unit 200 so as to display a mark of the mark unit 400 in a convenient way for a user to read the mark easily.

The display unit 500 includes at least a display panel configured to display images. That is, components used to display images are included in a block of the display unit 500.

If the display unit 500 is pivoted by 90 degrees, the mark unit 400 displays a mark in a horizontal direction (that is, a direction in which a user can conveniently read characters or symbols of the mark) regardless of pivoting of the display unit 500. For example, the mark unit 400 includes a first mark unit 410 configured to display a mark when the display unit 500 is horizontally oriented and a second mark unit 420 configured to display a mark when the display unit 500 is vertically oriented.

The state detection unit 200 detects the rotation state (orientation) of the display unit 500. The state detection unit 200 includes a slope sensor disposed in the display unit 500 for being inclined according to the rotation of the display unit 500.

The slope sensor may be a capacitive slope sensor, a metal-ball slope sensor, or an electrolyte slope sensor. In the electrolyte slope sensor, when electrolyte filled in a sealed space is inclined, a voltage variation of a plurality of electrodes making contact with the electrolyte is detected to measure a slope. In the metal-ball slope sensor, a slope is measured by detecting a contact between a metal ball disposed in a closed space and one of a plurality of electrodes. In the capacitive slope sensor, a slope is measured by detecting a capacitance value varying according to the position of a dielectric material disposed in a portion of a space between inner and outer electrodes.

Any one of such slope sensors may be used in the current embodiment. For example, the metal-ball slope sensor may be used when an inexpensive, easy-to-install sensor is necessary.

Referring to FIG. 2, the first and second mark units 410 and 420 are disposed at the peripheral region of a front filter 70 of a display device 1. The front filter 70 is used for protecting an inner display panel, blocking electromagnetic interference (EMI), filtering spill light, and/or other purposes.

The front filter 70 is disposed on the front side of the display device 1 and has a rectangular shape. The first mark unit 410 is disposed at a horizontal lower edge region of the front filter 70, and the second mark unit 420 is disposed at a vertical right edge region of the front filter 70. The edges of the front filter 70 is supported and protected by a front frame 90. When the display device 1 is horizontally (transversely) oriented, a mark of the first mark unit 410 is displayed so that users can conveniently use the display device 1. That is, when the display device 1 is horizontally oriented, users can view a properly oriented mark (including characters or symbols) through the first mark unit 410.

If the display device 1 is rotated to a vertical (longitudinal) orientation, a mark is displayed on the second mark unit 420 so that users can conveniently use the display device 1.

Referring to FIG. 3, the mark unit 400 includes a mark region 412 for displaying a mark and an illumination unit 411 for illuminating the mark region 412 with light.

The mark region 412 is a predetermined region of the display unit 500—in the current embodiment, a predetermined region of the front filter 70. The mark region 412 includes a semitransparent region 413 to which a semitransparent paint is applied to form characters or a figure, and the remaining area of the mark region 412 is an opaque region 414. The opaque region 414 is disposed along the edge of the front filter 70.

The illumination unit 411 cast light to the mark region 412 from the backside of the mark region 412. The illumination unit 411 may be a light emitting diode (LED). Therefore, when the illumination unit 411 is turned on, light passes through the semitransparent region 413 so that a mark can be display on the mark region 412, and when the illumination unit 411 is turned off, a user cannot perceive the mark region 412.

The semitransparent region 413 can be transparent. In this case, however, an inner component of the display device 1 can be seen. That is, although the illumination unit 411 is turned off, the semitransparent region 413 can be distinguished from the opaque region 414 so that a mark of the semitransparent region 413 can be perceived. As shown in FIG. 3, the mark region 412 may be defined at the front filter 70 and semitransparent like a semitransparent region of the front filter 70.

An exemplary operation of the mark displaying apparatus will be described with reference to FIGS. 1 to 3. In addition, FIG. 6 in which an exemplary operation of the display device 1 is explained will also be used to explain the exemplary operation of the mark displaying apparatus.

Referring to FIG. 6, when the display unit 500 is in horizontal state—this horizontal state may be a normally used state of the display unit 500, the first mark unit 410 is in a bright state. If the display unit 500 is rotated, the state detection unit 200 detects the rotation of the display unit 500. Rotation information detected by the state detection unit 200 is transmitted to the control unit 300. According to the received rotation information, the control unit 300 may turn off the first mark unit 410 and turn on the second mark unit 420.

The first or second mark unit 410 and 420 may be in a bright state when light emitted from the illumination unit 411 passes through the semitransparent region 413 of the mark region 412. Light emitted from the illumination unit 411 may not pass through the opaque region 414.

Owing to the above-described operation of the display device 1 and the mark displaying apparatus, a product mark can be displayed on a lower center position—that is, a position where the product mark is located when the display device 1 is manufactured—of the display device 1 regardless of the (vertical/horizontal) orientation of the display device 1. When the illumination unit 411 is turned off, a user may not perceive a mark of the mark unit 400 since the semitransparent region 413 does not transmit light substantially.

The structure of the mark unit 400 in the display device 1 will now be described in more detail.

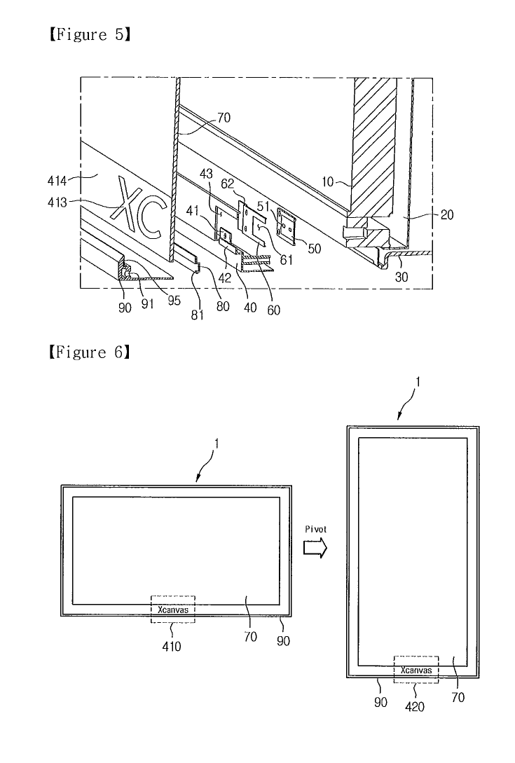

FIG. 4 is a sectional view taken along line I-I′ of FIG. 2 for illustrating the first mark unit 410 of the display device 1, and FIG. 5 is an exploded perspective view of the display device 1 for illustrating the first mark unit 410 in more detail. In FIGS. 4 and 5, the first mark unit 410 is mainly illustrated. The second mark unit 420 may have the same structure as that of the first mark unit 410 illustrated in FIGS. 4 and 5. Although the sectional view of FIG. 4 illustrates the right side of the section of the first mark unit 410, the structure of the left side of the section may also be easily understood because the left and right sides are symmetrically provided.

Referring to FIGS. 4 and 5, the front frame 90 is disposed at a front side of a display panel 10, and a back cover 30 is disposed at a rear side of the display panel 10. The position of the display panel 10 is supported by an inner frame 40. The front filter 70 is fixed to the front frame 90 using a filter fixing member 80, and a shock absorbing member 95 such as a sponge is disposed between the front filter 70 and the front frame 90. A main frame 20 is installed on the display panel 10 so that components such as an image driving substrate can be mounted on the main frame 20.

An opening 43 is formed through the inner frame 40, and a bracket 60 is disposed along the opening 43. A light emitting unit 50 is fixed to the bracket 60. A plurality of LEDs 51 are mounted at the light emitting unit 50. An opening 61 is formed in the bracket 60 so that light emitted from the light emitting unit 50 can pass through the opening 61.

The inner frame 40 includes a first installation rib 41 and a second installation rib 42. The first and second installation ribs 41 and 42 are spaced apart from each other in a front-to-back direction so that the bracket 60 can be inserted between the first and second installation ribs 41 and 42. That is, a lower end portion of the bracket 60 may be inserted between the first and second installation ribs 41 and 42. A rest rib 62 formed by bending a side portion of the bracket 60 makes contact with a rear surface of the inner frame 40. Owning to this structure, the bracket 60 can be fixed to a preset position without horizontal and vertical positional errors.

Since the rest rib 62 is formed by the side portion of the bracket 60, the bracket 60 and the light emitting unit 50 can be inserted through the opening 43 of the inner frame 40. Therefore, the light emitting unit 50 and the bracket 60 do not increase the total thickness of the display device 1 substantially.

The filter fixing member 80 includes a forwardly projecting protrusion 81, and the front frame 90 includes a guide hole 91. Therefore, the filter fixing member 80 can be reliable fixed to a preset position of the front frame 90 by inserting the protrusion 81 into the guide hole 91.

The opaque region 414 and the semitransparent region 413 are disposed at the front filter 70, and the semitransparent region 413 is aligned with the opening 43. Therefore, light emitted from the light emitting unit 50 can be travel to the outside through the opening 43 and the semitransparent region 413. Since light emitted from the light emitting unit 50 passes through the semitransparent region 413, a mark of the semitransparent region 413 such as characters or a figure can be perceived.

In the above-described embodiment, the most part of the edge region of the front filter 70 is opaque, and the remaining specific part of the edge region of the front filter 70 is semitransparent. Therefore, light can pass through the semitransparent part of the edge region of the front filter 70.

### Another Embodiment

In the following description of the current embodiment, the same elements as those of the previous embodiment will be denoted by the same reference numerals.

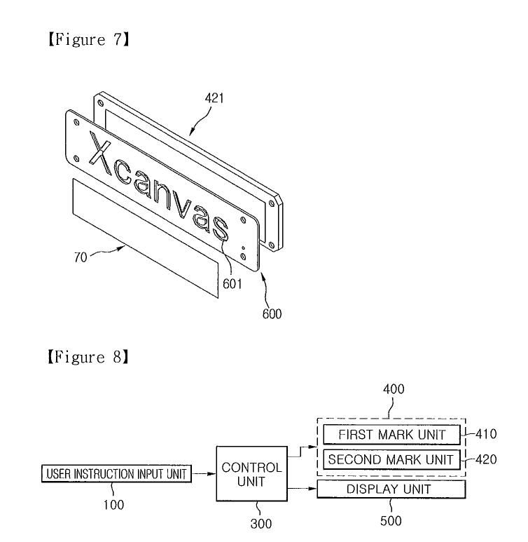

FIG. 7 is an exploded perspective view illustrating a mark unit according to another embodiment.

Referring to FIG. 7, a mark unit of a mark displaying apparatus of a display device is illustrated according to another embodiment. The mark unit includes a shield film 600 configured to transmit light selectively for displaying a mark, an illumination unit 421 disposed at the backside of the shield film 600, and a front filter 70 disposed at the front side of the shield film 600. Slots 601 are formed in the shield film 600 in the shape of desired characters, a pattern, or a logo.

When the illumination unit 421 is turned on, light passes through the slots 601 so that a mark corresponding to the shape of the slots 601 is displayed. When the illumination unit 421 is turned off, no light passes through the slots 601 so that a user cannot perceive the mark. The front filter 70 is formed of a semitransparent material so that the slots 601 are not hide visible but only the front filter 70 is visible when viewed from the outside.

That is, the slots 601 of the shield film 600 have the same function as the mark region 412 of the previous embodiment. In the current embodiment, the front filter 70 covers the shield film 600 to hide the shield film 600. However, the front filter 70 can be provided in other manners for hiding the shield film 600.

The current embodiment is advantageous in that it is unnecessary to treat or modify the front filter 70 in a specific manner; however, there is characters that cannot be expressed by slots such as an ‘A’ and an ‘O.’ Such characters may be expressed in other manners.

In the above-described embodiments, when the orientation of the display unit 500 is changed, the orientation change is automatically detected to display a mark properly. That is, the function of the state detection unit 200 used to detect the orientation (pivoted state) of the display unit 500 is important. In the following embodiment, however, the state detection unit 200 is omitted.

### Another Embodiment

Elements of the current embodiment are the same as those of the previous embodiments; however, the operation of a mark unit is different. Detailed descriptions of the same elements will be omitted because the same descriptions are given in the previous embodiments.

FIG. 8 is a block diagram illustrating a mark displaying apparatus of a display device according to another embodiment.

Referring to FIG. 8, the current embodiment is characterized by a user instruction input unit 100 provided as a replacement of the state detection unit 200. The user instruction input unit 100 may be a remote control of a display device or a switch installed at a main body of the display device.

In the current embodiment, when the orientation of a screen is changed due to a rotation of a display unit 500, a user can directly change the displaying state of first and second mark units 410 and 420 by manipulating the display device using the user instruction input unit 100. That is, when the display unit 500 is horizontally oriented, a user can manipulate the display device to display a mark on the first mark unit 410, and when the display unit 500 is vertically oriented, a user can manipulate the display device to display a mark on the second mark unit 420.

In this way, the display device can be used more reliably.

In a modified version of the current embodiment, a state detection unit 200 can be provided as well as the user instruction input unit 100. The modified version of the current embodiment may be suitable for the case where the display unit 500 can be automatically rotated. In this case, the user instruction input unit 100 may be used to rotate the display unit 500 automatically instead of being used to control the first and second mark units 410 and 420.

In detail, if a pivot instruction is input through the user instruction input unit 100, the display unit 500 is rotated by 90 degrees. The changed orientation of the display unit 500 is detected using the state detection unit 200. Then, a control unit 300 controls lighting of the first and second mark units 410 and 420 according to the orientation of the display unit 500—that is, according to whether the orientation of the display unit 500 is substantially horizontal or vertical.

In the previous embodiments, the color and brightness of a mark displayed on the mark unit are not changed. In these cases, a user can be bored. Therefore, the following embodiment provides a display device of which the color and brightness can be changed.

### Another Embodiment

The current embodiment is characterized by a coupling structure of a display device-particularly, the structure of a filter assembly including a front filter. In the following description of the current embodiment, the same elements as those of the previous embodiments will not be described in detail.

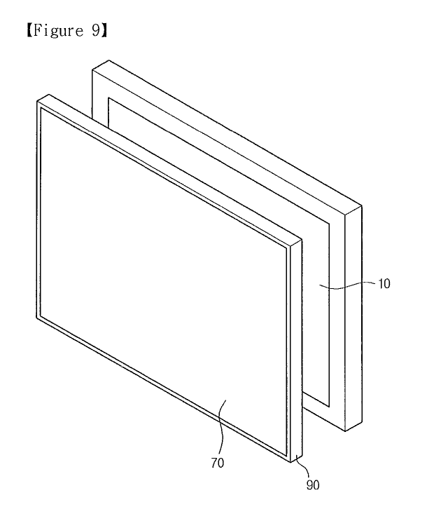

FIG. 9 is an exploded perspective view illustrating a display device according to another embodiment. In FIG. 9, a front filter 70 and a front frame 90 of a display panel 10 are disassembled. That is, a filter assembly is disassembled.

The structure of the display device will now be described in more detail according to another embodiment with reference to FIG. 9. FIGS. 4 and 5 may also be used to describe the current embodiment.

The inner frame 40 may be coupled to the back cover 30. In this case, the front and lower sides of the display panel 10 are supported by the inner frame 40, and the backside of the display panel 10 is supported by the back cover 30. The front filter 70 is fixed to the front frame 90 via the filter fixing member 80. The front frame 90 may be coupled to the back cover 30. In this case, the display panel 10 is not supported by a filter assembly constituted by the front filter 70, the filter fixing member 80, and the front frame 90, so that the filter assembly can be easily detached from a main body of the display device.

Therefore, if necessary, only the filter assembly, in which the front filter 70, the filter fixing member 80, and the front frame 90 are integrally assembled, can be detached from the display device without having to disassemble the display panel 10 or the display device wholly. Although the filter assembly is detached, other parts of the display device such as the display panel 10 and the inner frame 40 are stably placed at their original positions.

The detached filter assembly can be disassembled to replace some parts with new parts having desired colors, shapes, or designs, and then the filter assembly can be assembled again.

Therefore, according to the current embodiment, when a user is tired of the display device, the user can replace parts of the display device with new parts having different colors, shapes, or designs. The frontal appearance of the display device may be the most important factor that satisfies a user, and thus the current embodiment is useful in that point of view.

As described above, the filter fixing member 80 includes the forwardly projecting protrusion 81, and the front frame 90 includes the guide hole 91. Therefore, the filter fixing member 80 can be conveniently fixed to a preset position of the front frame 90 by inserting the protrusion 81 into the guide hole 91.

Although embodiments have been described with reference to a number of illustrative embodiments thereof, it should be understood that numerous other modifications and embodiments can be further devised from the spirit and scope of the principles of this disclosure. In the following description, other exemplary modifications and embodiments will be explained.

In the above-described embodiments, two mark units 410 and 420 are provided: one in the horizontal (lengthwise) direction of the display device, and the other in the vertical (widthwise) direction of the display device. However, the scope of the principles of the present disclosure is not limited thereto. For example, three mark units may be provided at edge portions of the display device in horizontal and vertical directions of the display device. In this case, a mark can be displayed at a proper position although the display device is rotated clockwise or counterclockwise.

In addition, since the display color of the mark unit 400 varies according to the color of the semitransparent region 413 and the wavelength of light emitted from the light emitting unit 50, various colors can be displayed on the mark unit 400 by only changing the color of the semitransparent region 413 or the wavelength of light emitted from the light emitting unit 50.

In addition, instead of forming the semitransparent region 413 using a semitransparent paint, the semitransparent region 413 can be formed using a film having a predetermined color, brightness, and saturation. However, if convenience in manufacturing is important, the semitransparent region 413 may be formed using a semitransparent paint. This modification may be more useful when combined with the embodiment illustrated in FIG. 9.

In addition, a light emitting display component such as a vacuum fluorescent display (VFD) capable of displaying a mark may be used for the light emitting unit 50, instead of LED(s). In this case, the same effect can be obtained by making the front filter 70 wholly semitransparent without having to form an opaque region at the front filter 70. However, in the cause where a precise mark, product cost reduction, and manufacturing cost reduction are necessary, LEDs may be used for the light emitting unit 50.

In the above-described embodiments, a mark is formed by the opaque region 414 and the mark region 412 of the front filter 70. However, the scope of the principles of the present disclosure is not limited thereto. For example, the front filter 70 may be reduced in size, and an opaque region and a semitransparent region may be formed at an additional transparent member and aligned with the light emitting unit 50. In this case, other structures or operations may be the same as in the above-described embodiments. However, in the case where convenience in manufacturing, manufacturing cost reduction, and aesthetics are important, the front filter 70 may not be reduced in size for using the additional transparent member.

### INDUSTRIAL APPLICABILITY

The embodiments are applicable to display devices, and thus the industrial applicability of the embodiments is high.

1-19. (canceled)

20. An apparatus for displaying a mark of a display device, the apparatus comprising:
a display unit configured to display images;
at least two mark units disposed at a front region of the display unit and spaced apart from each other;
a state detection unit configured to detect whether the display unit is in a horizontal or vertical orientation; and
a control unit configured to operate at least one of the mark units according to a detection signal of the state detection unit.

21. The apparatus according to claim 20, wherein the mark units comprise:
a first mark unit configured to operate when the display unit is in the horizontal orientation; and
a second mark unit configured to operate when the display unit is in the vertical orientation.

22. The apparatus according to claim 20, wherein each of the mark units comprises:
a mark region on which a mark is displayed; and
an illumination unit disposed at a rear side of the mark region for illuminating the mark region.

23. The apparatus according to claim 22, wherein the mark region comprises:
a semitransparent region disposed at a transparent part of the display unit for providing a predetermined mark; and
an opaque region disposed at a region excluding the semitransparent region for blocking light emitted from the illumination unit.

24. The apparatus according to claim 22, wherein the mark region comprises:
a shield film comprising a slot having a predetermined mark shape; and
a transparent part disposed at a front side of the shield film.

25. The apparatus according to claim 22, wherein the illumination unit comprises a light emitting unit, and the light emitting unit comprises a light emitting diode (LED).

26. The apparatus according to claim 22, wherein the mark region is disposed at a front filter of the display device.

27. The apparatus according to claim 22, wherein the control unit is configured to turn on one of the illumination units according to the horizontal or vertical orientation of the display unit.

28. The apparatus according to claim 20, wherein one of the mark units which is currently placed at a lower center portion of the display unit according to an orientation of the display unit is operated by a control signal of the control unit.

29. A display device comprising:
a display panel;
a back cover configured to protect a rear side of the display panel;
an inner frame configured to support an edge portion of the display panel;
at least two opening formed in the inner frame and spaced apart from each other;
light emitting units aligned with the openings, respectively;
a front filter configured to cover at least the display panel;
a filter fixing member configured to support the front filter; and
a front frame configured to cover an edge portion of the front filter.

30. The display device according to claim 29, wherein at least one of the openings is disposed at a horizontal edge portion of the display panel, and the other of the openings is disposed at a vertical edge portion of the display panel.

31. The display device according to claim 29, wherein the light emitting unit is selectively turned on.

32. The display device according to claim 29, wherein the front filter covers front sides of the openings.

33. The display device according to claim 29, wherein the filter fixing member is coupled to the front frame, and
the filter fixing member, the front filter, and the front frame are integrated to be separated from the display device at the same time.

34. The display device according to claim 29, further comprising a shock absorbing member between the front frame and the front filter.

35. The display device according to claim 29, wherein the light emitting units are disposed in the openings.

36. A display device comprising:
a pivotable display panel configured to display images; and
at least two mark units disposed at outer regions of the display panel that are not used for displaying images, the mark units being spaced apart from each other,
wherein each of the mark units comprises:
a light emitting unit; and
a mark region disposed at a front side of the light emitting unit for selectively transmitting light emitted from the light emitting unit.

37. The display device according to claim 36, wherein the mark region is positioned at a front filter disposed at a front side of the display panel.

38. The display device according to claim 36, wherein the mark region is foamed using an opaque paint.

39. The display device according to claim 36, wherein the mark region is formed using a shield film comprising a mark-shaped slot.

40. The display device according to claim 36, further comprising:
a state detection unit configured to detect a rotated angle of the display device; and
a control unit configured to turn on at least one of the light emitting units according to a detection signal of the state detection unit.
